(19) United States
(12) Patent Application Publication
(10) Pub. No.: US 2006/0264323 A1
(43) Pub. Date: Nov. 23, 2006

(54) Catalyst structure particularly for the production of field emission flat screens

(76) Inventors: Jean Dijon, Champagnier (FR); Thomas Goislard, Saint-Ismier (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/546,284

(22) PCT Filed: Feb. 24, 2004
(86) PCT No.: PCT/FR04/50076

§ 371 Date: Jul. 19, 2006

(30) Foreign Application Priority Data
Feb. 28, 2003 (FR) 03/02460

(51) Int. Cl. B01J 23/00; B05D 5/12

(52) U.S. Cl. 502/325; 427/122

(57) ABSTRACT

The invention relates to a method of structuring a catalyst on a support, characterised in that it comprises the following stages: depositing of a layer of catalyst on the support; annealing of the structure thus created to obtain a fractionation of the layer of catalyst in the shape of drops; etching of the fractionated layer of catalyst to adjust the density of the catalyst drops. The invention also relates to a method of carbon nanotube growth on the catalyst drops present on the structure obtained according to the method of structuring. Finally, the invention relates to a device comprising a cathode and an anode, the cathode comprising a layer of carbon nanotubes made according to the method of nanotube growth. No figures.

### TECHNICAL FIELD

The invention relates to a method of structuring a catalyst on a given support, said method allowing the density of the catalyst present on the support in the shape of drops to be controlled. The structure thus obtained is particularly useful for the manufacturing of flat screens with field emission at a low cost, said screens being constituted of a layer of carbon nanotubes emitting electrons, the nanotubes being obtained via growth on the catalyst drops.

### STATE OF THE PRIOR ART

The visualisation devices generally used operate via cathodoluminescence stimulated by the emission of an electric field. These devices are composed of a cathode, which is the emitting structure of electrons, and an anode, facing the cathode, which is covered by a luminescent layer, the anode and the cathode being separated by a space in which a vacuum is created.

The cathode is either a source of micro-tip based electrons or a source of electrons of an emitting layer base of weak threshold field, for example a layer of carbon nanotubes.

Now, in the case of carbon nanotubes, the emission performances of these nanotubes depend on the arrangement of said tubes on the surface of the layer. In particular, the density of the nanotubes is an important parameter to control. Indeed, if the density of the tubes is too high, not all of the tubes will see the electric field which they are subject to, this being due to a screen phenomenon. We thus obtain a layer whose density of tubes truly emitting electrons, or emissive sites, is low. Note, that for all the sites emitting electrons, the distance between the tubes must ideally be the same size as their length.

Furthermore, the emission threshold field of the tubes, that is to say the field value for which the produced current reaches a significant value, depends on the ratio between the length of the tube and its diameter. As we strive to obtain layers of nanotubes whose threshold field is low, the height of the tubes is typically a few micrometers, considering the diameter of the tubes which is typically 10 nm.

So we can see the technological benefits that can be obtained from layers of nanotubes whose diameter and density are controllable.

One of the retained methods used to increase the nanotubes is chemical vapour deposition. This depositing uses a carbon deposition reaction on a catalyst (typically iron, cobalt, nickel or an alloy of these materials). Consideration must be given to the fact that, as the nanotubes will grow on the catalyst particles, it is the distribution and the diameter of said catalyst particles which will govern the diameter and density of the obtained carbon tubes. The problem of controlling the geometric parameters of the nanotubes (diameter and spacing) therefore comes down to the problem of controlling the parameters of the catalyst particles.

Now, a method generally employed to control the parameters of the catalyst particles is to use the phenomenon of natural fractionation which arises on the very thin layers of catalyst when they are brought to a sufficiently high temperature (FIGS. 1a and 1b). The method of structuring a catalyst via the method of fractionation according to the prior art starts with the depositing, at room temperature, of a layer of catalyst 2 on a given support 1 (FIG. 1a). Then, we anneal the layer of catalyst 2 at a high temperature (for example 600° C.) and we obtain the result shown in FIG. 1b: we can now see that the catalyst is on the support in the shape of drops 3, 4. However, the problem with this method is that the density of the catalyst drops is not controlled. With this method of fractionation we obtain a distribution of drops in which the average diameter depends on the thickness of the deposited continuous layer, the density of the drops being non-adjustable. For example, we can see in FIG. 2 that we obtain, from layers of 10 nm thick nickel (curve 5), an average diameter of drops of about 60 nm after an increase in temperature of between 500° C. and 600° C. But if the layer of Ni is 3 nm thick (curve 6), we obtain an average diameter of drop of about 35 nm. Note that these results depend on the materials onto which the layer of catalyst is deposited. Furthermore, we can also see in FIG. 2 that the dispersion of the diameters of drops is significant when this method is used. For example, for a layer of 10 nm thick Ni (curve 5), the diameters of drops obtained typically fall between 10 and 200 nm. Knowing that the typical distances between the drops are about 100 nm, this results in a very high density of nanotubes and a non-optimised emissive site density for field emission. By reducing the thickness of the layer of catalyst (in this case nickel), we obtain smaller drops, along with a higher density of drops. This density is not satisfactory for our application given the phenomena of the aforementioned screen. From this we deduct that the controlling of the density of the catalyst drops and therefore of the particle growth of the nanotubes is not managed by this method.

However, to control the density of the catalyst drops, there is a method which consists in etching on the layer of catalyst small patterns (typically a few 100 nm in diameter) via high-resolution photo-lithographic methods (see document [1] mentioned at the end of this description). Now even if these methods are efficient, they are however very expensive. We cannot therefore use them to make large surface devices at reduced cost such as flat screens.

Another problem is to be considered. The high temperature stage, which allows catalyst drops to be formed, cannot be performed on just any type of material due to the problems of the catalyst diffusion in the underlying materials.

### PRESENTATION OF THE INVENTION

The purpose of the invention is to allow the control of the physical parameters (diameter and density) of the catalysts deposited on the support without the need to use a high-resolution photo-lithographic method. The invention thus makes it possible to control the parameters of the carbon nanotubes which will grow on these catalysts. In particular, the method according to the invention notably renders possible the making, at reduced cost, of large surface supports containing nanotubes, said supports being necessary for the making of flat screens.

This purpose and still others are reached, in compliance with the invention, via a method of structuring a catalyst on a support. This method will allow the density of the catalyst drops present on said support to be controlled. This method has several stages. Firstly, we deposit a layer of catalyst on a support. Note that the chosen support must be appropriate for the implementation of the method. The depositing of the layer of catalyst can advantageously be carried out at room temperature. We then perform the vacuum annealing or annealing under controlled atmospheric conditions of the newly made structure. This stage allows a fractionation of the layer of catalyst in the shape of drops to be obtained. Finally, we etch on the fractionated layer of catalyst so as to adjust the density of the catalyst drops. We thus obtain drops of set diameter and density.

According to a particular embodiment, said method further comprises a preliminary depositing stage on the support of a barrier layer which forms a barrier against interactions between the support and the catalyst. The depositing of the barrier layer can advantageously be performed at room temperature. In this case the function of the barrier layer is to prevent interactions between the catalyst and the support, and in particular a contamination of the catalyst which could hinder the etching. These different stages are illustrated in FIGS. 3a, 3b, 3c and 3d.

Advantageously, the etching of the fractionated layer of catalyst can be an etching of the catalyst using an etchant for a fixed length of time.

Advantageously, the etching of the fractionated layer of catalyst can also be performed via dry etching, plasma etching (RIE, ICP, etc.) or via selective ionic bombardment.

According to a particular embodiment, we can decide to use a mask so as to deposit the layer of catalyst, and subsequently the nanotubes, on only certain parts of the support. To do so, before depositing of the layer of catalyst on the support, we make a mask on the support, the mask exposing the support through openings. The mask can for example be in resin, aluminium or any other material classically used in microelectronics as a sacrificial layer and compatible with the depositing of the catalyst. We then deposit the layer of catalyst according to the previously explained protocol. Then, we remove the mask and anneal the structure. We then perform the chemical etching stage of the catalyst.

If we decide to deposit a barrier layer between the substrate and the layer of catalyst, the mask can be made on the support before the depositing of the barrier layer. We will then remove the mask after having deposited the layer of catalyst on the structure and anneal said structure.

According to an alternative embodiment, the sublayer can be evenly deposited over the entire support; the depositing of the catalyst is performed, thanks to a mask, in a localised manner on some parts of the support. In this case, we start by depositing the barrier layer on the support and then make the mask on the barrier layer, the mask exposing said layer through openings. All we will then have to do is remove the mask after having deposited the layer of catalyst on the structure and anneal this structure.

Regarding the etchant of the fractionated layer of catalyst according to the method of structuring of the invention, it could advantageously be a solution which selectively etches the catalyst.

Among the etchants of the fractionated layer of catalyst, we will advantageously choose an etchant that does not prevent the catalyst from reacting to the elements that it should subsequently catalyse. Indeed, some etchants tend to contaminate the catalyst and render the catalyst drops inefficient with respect to the growth of nanotubes.

The thickness of the layer of catalyst will be chosen so that after etching, the average diameter of the drops will correspond to the diameter of the nanotubes that we aim to grow (typically between 10 nm and 50 nm). The length of etching will be chosen so as to obtain an optimal density of the drops for the purposed application, in the light of the homogenous initial distribution of the drops obtained after fractionation. We thus exploit the fact that fractionation leads to a static dispersion of the diameters, the biggest diameters being the rarest and the drops of these diameters being relatively set apart from each other.

Another purpose of the invention consists in the making of carbon nanotubes on a support. To do so we use a support with structured catalyst drops according to the aforementioned method, and we grow the carbon nanotubes on said drops. In other words, the invention consists in a method of carbon nanotube growth on the catalyst drops present on the structure obtained according to the method of structuring a support, said method consisting in depositing carbon on the catalyst drops already present, for example via chemical vapour deposition of carbon.

According to a particular embodiment, the depositing of the barrier layer is a depositing of TiN or TaN.

Advantageously, the depositing of the layer of catalyst is a depositing of an element chosen from among the group comprising Fe, Co, Ni, Pt, Au or any alloy of these materials.

The invention also relates to a device comprising a cathode and an anode covered by a luminescent layer, the anode being placed facing the cathode, and the anode and the cathode being separated by a space in which we create a vacuum. This device is different from the devices of the prior art in that the cathode comprises a layer of carbon nanotubes made via the method of nanotube growth according to the invention.

### BRIEF DESCRIPTION OF THE DRAWINGS

The invention will be better understood and other advantages and particularities will appear upon reading the following description, given by way of non-restrictive example, accompanied by the annexed drawings among which:

FIGS. 1a and 1b show the different stages of a typical method of structuring a catalyst via fractionation of a thin layer at high temperature;

FIG. 2 is a graph showing the static distribution of the diameters of catalyst drops according to the thickness of the layer of catalyst;

FIGS. 3a to 3d illustrate the different stages of the method of structuring a catalyst according to the invention.

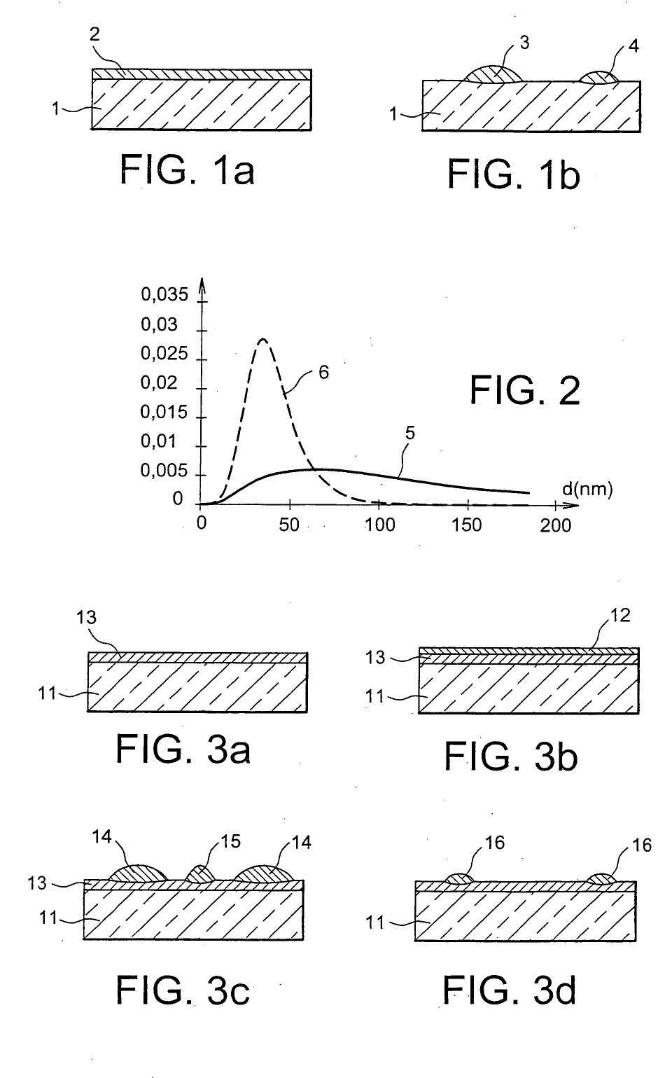

### DETAILED PRESENTATION OF PARTICULAR EMBODIMENTS

As a first embodiment, we will grow carbon nanotubes on nickel. The support used can be in silicon. It can, more generally, be in a semiconductor material, steel or be composed of a stack of any of these materials or other materials, the barrier layer allowing if needs be to insulate, in particular chemically, the support from the catalyst. This barrier layer is not necessary if the support intrinsically has the quality of the required barrier, as is the case for example with a silica or glass support.

We start by depositing on a support, for example a glass support covered by a layer of silicon, the barrier layer 13 or sublayer which will isolate the catalyst 12 from the support 11 chemically speaking in particular (see FIG. 3a). The depositing takes place at room temperature via magnetron spluttering and the sublayer deposited is a layer of TiN or TaN with a thickness of between 30 nm and 80 nm. Then we deposit a layer 12 of nickel with a thickness of 10 nm on the sublayer 13 at room temperature and by evaporation using an electron gun (FIG. 3b). We then carry out a vacuum or partial pressurised hydrogen annealing of the structure thus obtained at a temperature of 600° C. for 1 hour so as to create drops 14, 15 and 16 of the layer of catalyst 12 (FIG. 3c). Finally, the catalyst undergoes an etching using a solution made by mixing a volume of nitric acid, a volume of acetic acid and four volumes of water. The etching is carried out for a period of 45 seconds. Once this etching has terminated, we obtain drops 16 of a set diameter and density (FIG. 3d).

The etchant used above can be replaced with a solution of hydrochloric acid diluted to 5%. We thus obtain similar results in terms of dispersion and the size of the drops. On the other hand, the efficiency of the catalyst for carbon nanotube growth is greatly reduced after this chemical treatment: it seems that the solution of hydrochloric acid diluted to 5% contaminates the catalyst and diminishes its capacity to grow the carbon nanotubes. This solution can however be used for other applications or other types of materials, or in the case where a catalyst efficiency control is desired.

In the second embodiment, we use a lift-off mask. We make this lift-off mask on the support 11 before starting the depositing of the sublayer 13 and of the catalyst 12. Then we deposit on the support 11, at room temperature, a layer 13, which will act as a sublayer, of TiN or TaN with a thickness of between 30 nm and 80 nm, via magnetron spluttering. The structuring of the barrier layer allows the catalyst to be confined (towards the support but also in the plane of the deposit). We then deposit on the sublayer 13 a layer of Ni catalyst of 10 nm thick at room temperature by evaporation using an electron gun. We then remove the lift-off mask and vacuum anneal the structure at 600° C. for 1 hour. Finally, we etch the fractionated layer of catalyst using a solution composed of a volume of nitric acid, a volume of acetic acid and four volumes of water. This etching is performed for a period of 45 seconds.

To illustrate these advantages, notably in terms of emissive site density, obtained using the method of nanotube growth according to the invention, we compared the emission characteristics of the layer of nanotubes obtained with and without the implementation of said method.

Firstly, we choose a support capable of undergoing the different stages of the method of structuring and we deposit a sublayer of TiN with a thickness of 30 nm. Then we deposit a layer of Ni catalyst with a thickness of 10 nm. We then carry out the partial pressurised hydrogen annealing of this structure at a temperature of 600° C. for 1 hour. This annealing allows catalyst drops to be created and the catalyst to be activated. Finally, we grow the carbon nanotubes on the catalyst by performing a chemical vapour deposition (CVD) by sending to the catalyst a mixture constituted of 60 cm³/minute (60 sccm) of CO and 20 cm³/minute (20 sccm) of H₂. The layer of nanotubes thus obtained will act as a reference layer. With this layer, we obtain an emissive site density of 1.2*10⁶ per m² and an emission threshold of 4 V/μm.

We take the same structure as above (layer of TiN with a thickness of 30 nm and layer of Ni with a thickness of 10 nm) which we obtain after the vacuum annealing or annealing under controlled atmospheric conditions, and we etch, with the aforementioned mixture (nitric acid, acetic acid and water), the fractionated layer of catalyst for a period of 30 seconds. We then carry out the activation annealing of the catalyst (identical to the previous example) and we grow the carbon nanotubes on the catalyst drops via CVD with the mixture (CO and H₂) previously used. For this layer, known as layer 1, we obtain an emissive site density of 9.8*10⁶ per m² and an emission threshold of 4 V/μm.

If the etching period is prolonged and reachs 45 seconds, we obtain a layer, known as layer 2, where the emissive site density reachs 5.5*10⁷ per m² and the emission threshold reachs 3.4 V/μm.

In conclusion, by comparing the reference layer and layer 1, we note that the etching stage allows to eliminate a certain number of catalyst drops. The density of drops being lower, there is a greater number of nanotubes which detect the electric field passed through the device and consequently, the emissive site density increases.

By adjusting the etching period, we can find an optimal setting point for the application, for example the point with the highest emissive site density.

We thus see that the method of nanotube growth and in particular the method of structuring of the catalyst according to the invention allows the emissive site density to be adjusted and, in particular, increased, and therefore the current emitted by the layer of nanotubes to be increased by a factor potentially greater than 10 (45 in the best possible case).

### BIBLIOGRAPHY

[1] TEO and al., Applied Physics Letters, Vol 80, No. 11, pages 2011-2013.

1-13. (canceled)

14. A method of structuring a catalyst on a support, comprising the following stages:
depositing of a layer of catalyst on the support;
annealing of the structure thus created to obtain a fractionation of the layer of catalyst in the shape of drops;
etching of the fractionated layer of catalyst to adjust the density of the catalyst drops.

15. The method according to claim 14, further comprising, before the depositing stage of the layer of catalyst, a depositing stage on the support of a barrier layer which forms a barrier against interactions between the support and the catalyst.

16. The method according to claim 14, wherein the etching of the fractionated layer of catalyst is an etching chosen from among an etching of the catalyst using an etchant for a fixed length of time, a plasma etching or an etching by ionic bombardment.

17. The method according to claim 14, further comprising the following stages:
before depositing of the layer of catalyst on the support, making a mask on the support, the mask exposing the support through openings;
removing the mask after having deposited the layer of catalyst on the structure and before annealing of said structure.

18. The method according to claim 15, further comprising the following stages:
before depositing a barrier layer, making a mask on the support, the mask exposing the support through openings;
removing the mask after having deposited the layer of catalyst on the structure and before annealing of said structure.

19. The method according to claim 15, further comprising the following stages:
after depositing the barrier layer on the support, making a mask on the barrier layer, the mask exposing said layer through openings;
removing the mask after having deposited the layer of catalyst on the structure and before annealing of said structure.

20. The method according to claim 14, wherein the depositing of the layer of catalyst is done at room temperature.

21. The method according to claim 15, wherein the depositing of the barrier layer is done at room temperature.

22. The method according to claim 14, wherein the etchant of the fractionated layer of catalyst is a solution which selectively etches the catalyst.

23. A method of carbon nanotube growth on the catalyst drops present on the structure obtained according to claim 14, said method comprising depositing carbon on the catalyst drops.

24. The method of carbon nanotube growth according to claim 23, wherein the depositing of the barrier layer is a depositing of TiN or TaN.

25. The method of carbon nanotube growth according to claim 23, wherein the depositing of the layer of catalyst is a depositing of an element chosen among the group comprising Fe, Co, Ni, Pt, Au or any alloy of these materials.

26. A device comprising a cathode and an anode facing each other, the anode being covered by a luminescent layer, the anode and the cathode being separated by a space in which we create a vacuum, said device being characterised in that the cathode comprises a layer of carbon nanotubes made according to claim 23.
